(19) United States
(12) Patent Application Publication
(10) Pub. No.: US 2011/0133050 A1
(43) Pub. Date: Jun. 9, 2011

(54) Adjustable Mounting Assemblies with Locking Systems

(75) Inventors: Dean N. Eisenberger, SR., Plymouth Meeting, PA (US); Joseph J. Lessard, Horsham, PA (US); Ryan Kennedy, Ambler, PA (US)

(73) Assignee: FIRSTGROUP AMERICA, INC., Cincinnati, OH (US)

(21) Appl. No.: 12/962,853

(22) Filed: Dec. 8, 2010

Related U.S. Application Data
(60) Provisional application No. 61/267,622, filed on Dec. 8, 2009.

(51) Int. Cl. F16M 13/00; E05B 73/00; B23P 11/00

(52) U.S. Cl. 248/551; 70/58; 29/428

(57) ABSTRACT

A locking system for use in adjusting a mounting assembly includes a lock plate and a lock shaft mount. A lock shaft component is rotatably received within an opening of the lock of the lock plate and rotatably supported by the lock shaft mount. With the locking system in a locked configuration, the lock shaft component engages the lock plate which locks the positions of the lock plate relative to the position of the lock shaft mount. With the locking system in an unlocked configuration, the lock shaft component disengages the lock plate such that the lock plate moves along a length of the lock shaft component toward and away from the lock shaft mount.

### CROSS-REFERENCE TO RELATED APPLICATIONS

This application claims priority to U.S. Provisional Patent Application Ser. No. 61/267,622, filed Dec. 8, 2009, entitled “Key Threaded Sliding Cam Lock,” the details of which are hereby incorporated herein by reference.

### TECHNICAL FIELD

The present invention is generally directed to adjustable mounting assemblies having movable components that can be locked in a position.

### BACKGROUND

Various types of vehicle mounts are used to mount equipment in vehicles. Some examples include desks, modular consoles, radio mounts, etc. Mounts for equipment used by operators who often travel and/or work from their vehicles may be particularly useful to those operators. It is not uncommon, for example, for police officers to utilize a laptop computer in their vehicles. However, it can be cumbersome and distracting to utilize the computer in the operator's lap in the vehicle. Thus, mounting systems for equipment used in vehicles and other locations are desirable.

### SUMMARY

In one embodiment, a mounting assembly for mounting equipment thereon includes an adjustable mounting tray having an upper support surface for supporting equipment thereon. The adjustable mounting tray comprising a first tray component and a second tray component where at least one of the first and second tray components is moveable relative to the other of the first and second tray components to adjust a dimension of the adjustable mounting tray. A locking system includes a lock plate mounted to the first tray component. A lock shaft component is rotatably received within an opening of the lock plate. With the locking system in a locked configuration, the lock shaft component engages the lock plate which locks the positions of the first and second tray component relative to each other. With the locking system in an unlocked configuration, the lock shaft component disengages the lock plate such that the lock plate moves along a length of the lock shaft component to move at least one of the first and second tray components relative to the other of the first and second tray components.

In another embodiment, a locking system for use in adjusting a mounting assembly includes a lock plate and a lock shaft mount. A lock shaft component is rotatably received within an opening of the lock plate and rotatably supported by the lock shaft mount. With the locking system in a locked configuration, the lock shaft component engages the lock plate which locks the positions of the of the lock plate relative to the position of the lock shaft mount. With the locking system in an unlocked configuration, the lock shaft component disengages the lock plate such that the lock plate moves along a length of the lock shaft component toward and away from the lock shaft mount.

In another embodiment, a method of mounting equipment to a support structure comprising: adjusting a dimension of an adjustable mounting tray having an upper support surface for supporting equipment thereon, the adjustable mounting tray comprising a first tray component and a second tray component where at least one of the first and second tray components is moveable relative to the other of the first and second tray components to adjust the dimension of the adjustable mounting tray; locking the positions of the first and second tray components relative to each other at any one of a plurality of incremental positions using a locking system that comprises: a lock plate mounted to the first tray component; a lock shaft component rotatably received within an opening of the lock plate; wherein, with the locking system in a locked configuration, the lock shaft component engaging the lock plate which locks the positions of the first and second tray component relative to each other; wherein, with the locking system in an unlocked configuration, the lock shaft component disengaging the lock plate such that the lock plate moves along a length of the lock shaft component to move at least one of the first and second tray components relative to the other of the first and second tray components.

### BRIEF DESCRIPTION OF THE DRAWINGS

The following detailed description of specific embodiments of the present invention can be best understood when read in conjunction with the drawings enclosed herewith.

FIG. 1 is a perspective view of a mounting assembly that is mounting a laptop computer according to one or more embodiments shown and described herein;

FIG. 2 is a perspective view of the mounting assembly of FIG. 1 in isolation;

FIG. 3 is bottom view of the mounting assembly of FIG. 2 according to one or more embodiments shown and described herein;

FIG. 4 is a perspective view of a cam lock component for use with the mounting assembly of FIG. 2 according to one or more embodiments shown and described herein;

FIG. 5 is a perspective view of a lock shaft component for use with the mounting assembly of FIG. 2 according to one or more embodiments shown and described herein;

FIG. 6 is a perspective view of a lock plate for use with the mounting assembly of FIG. 2 according to one or more embodiments shown and described herein;

FIG. 7 is another perspective view of the lock plate of FIG. 6 according to one or more embodiments shown and described herein; and

FIG. 8 illustrates the locking system for use with the mounting assembly of FIG. 2 in a locked configuration;

FIG. 9 illustrates the locking system for use with the mounting assembly of FIG. 2 in an unlocked configuration;

FIG. 10 illustrates operation of the locking system for use with the mounting assembly of FIG. 2 in an unlocked configuration with the lock plate of FIG. 6 movable along a length of the lock shaft component of FIG. 5;

FIG. 11 is a section view illustrating operation of the locking system in a locked configuration; and

FIG. 12 is a section view of the locking system in an unlocked configuration.

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

Embodiments described herein generally relate to mounting assemblies for securely mounting equipment, for example, within a vehicle or other location such as within a room such as an office. As one example, the mounting assemblies may be useful for mounting a laptop computer or other computing device such as a tablet computer or e-reader within a vehicle. The mounting assemblies are adjustable to accommodate a wide variety of equipment sizes and for ease of equipment mounting.

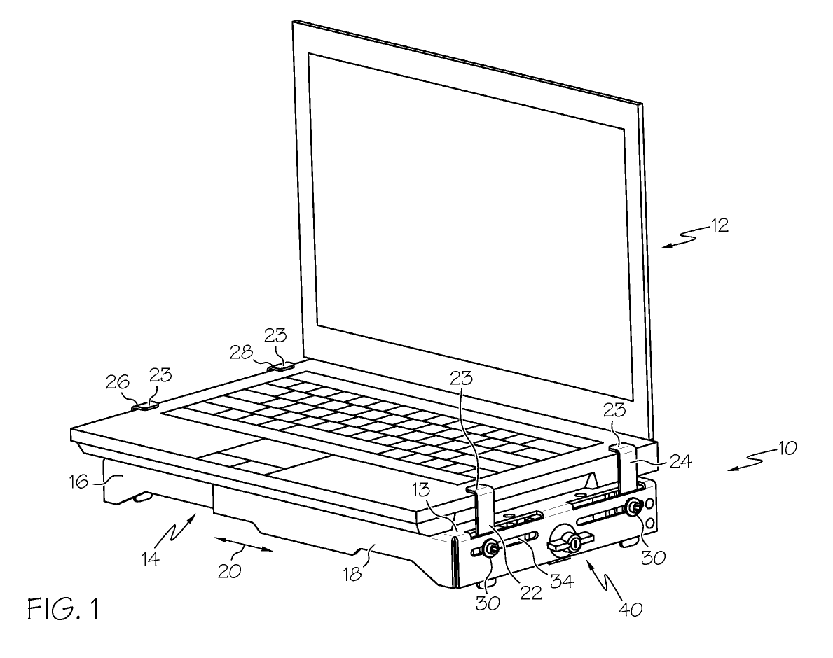

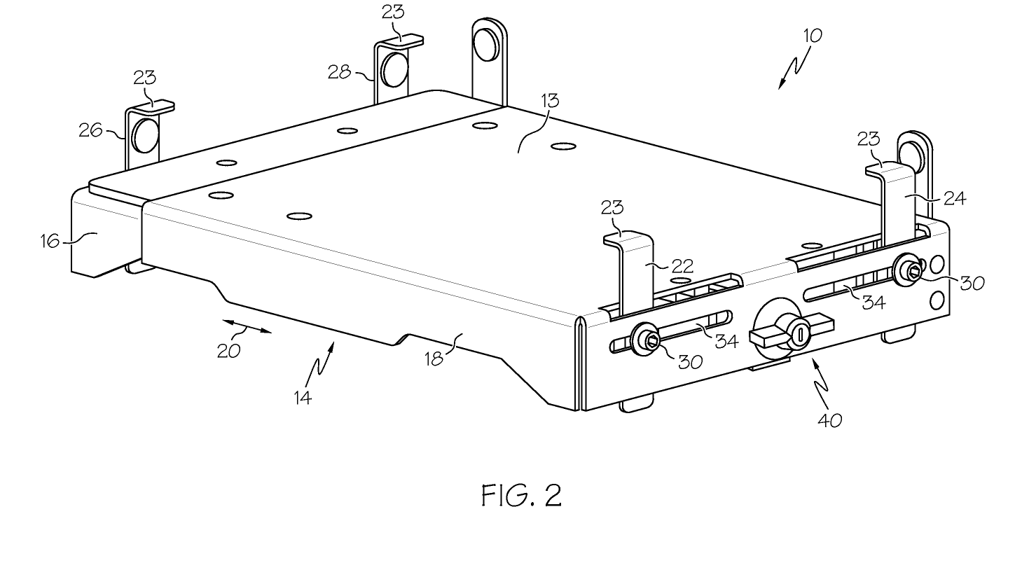

Referring to FIGS. 1 and 2, a mounting assembly 10 is illustrated securing a laptop computer 12 thereon (FIG. 1). The mounting assembly 10 includes an adjustable mounting tray 14 having an upper mounting surface 13 including a first tray component 16 and a second tray component 18. One or both of the tray components 16 and 18 may be moved relative to each other in the widthwise direction represented by arrow 20 to widen or shorten the width of the mounting tray 14. Hook-like mounting fingers 22 and 24 with overhanging portions 23 that overhang the upper mounting surface 13 are mounted to the tray component 18 for movement therewith and hook-like mounting fingers 26 and 28 with overhanging portions 23 are mounted to the tray component 16 for movement therewith. Adjustment of the sliding components 16 and/or 18 can bring the mounting fingers 22, 24, 26 and 28 into and out of engagement with the laptop computer 12 for locking and unlocking the laptop computer 12 to the mounting assembly 10.

In some embodiments, the positions of the mounting fingers 22, 24, 26 and 28 may be adjustable along the length of the mounting assembly 10. In the illustrated embodiment, fasteners 30 may be provided which can be used to slide the mounting fingers 22, 24, 26 and 28 along slots 34. Loosening the fasteners 30 allows for adjustment of the mounting fingers 22, 24, 26 and 28 and tightening of the fasteners 30 can be used to lock the mounting fingers 22, 24, 26 and 28 in place. In some embodiments, the height of the mounting fingers 22, 24, 26 and 28 may also be adjustable, for example, to accommodate equipment of different thicknesses.

A locking system, generally referred to as element 40 is used to lock the positions of the tray components 16 and 18 of the mounting tray 14 relative to each other. The locking system 40 has an unlocked configuration that allows one or both of the tray components 16 and 18 to move relative to the other and a locked configuration that prevents relative movement of the tray components 16 and 18.

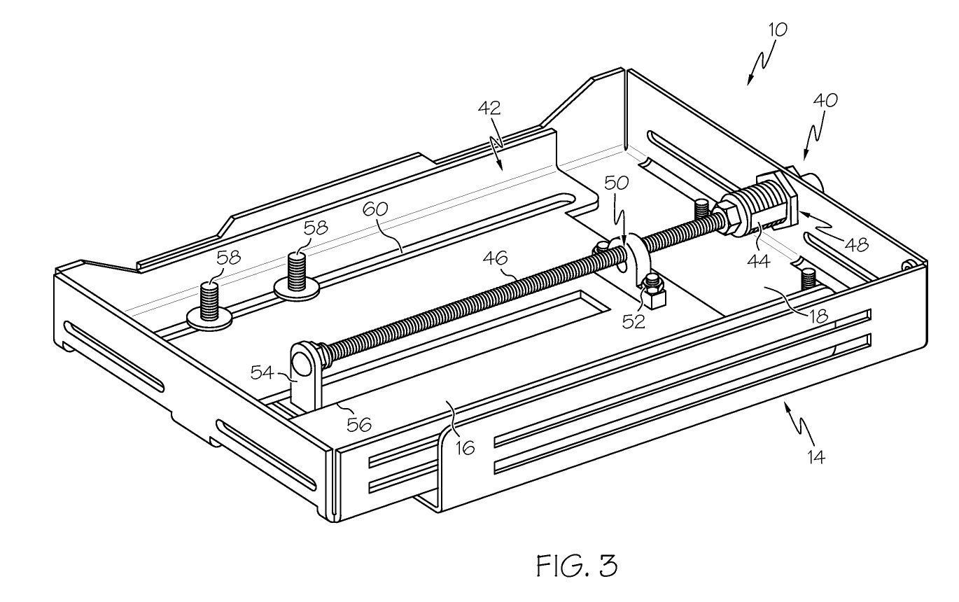

Referring to FIG. 3, a bottom side 42 of the mounting assembly 10 is shown highlighting the locking system 40. The locking system 40 includes a cam lock component 44 that is connected (e.g., threadably) to a lock shaft component 46 that is fed through an opening 48 in the mounting tray 14. The lock shaft component 46 is rotatably received within an opening 50 of a lock plate 52 that is mounted to the tray component 16 of the mounting tray 14. The opening 50 may have a diameter that is greater than a major diameter of the lock shaft component 46 such that the lock shaft component is slidable through the opening 50. A lock shaft mount 54 rotatably mounts an end of the lock shaft component 46. The lock shaft mount 54 is mounted to the tray component 18 through a slot 56. Guide pins 58 may be provided to guide the sliding components 16 and 18 while they are being adjusted. The guide pins 58 may be mounted to the tray component 18 and slidably received within a slot 60.

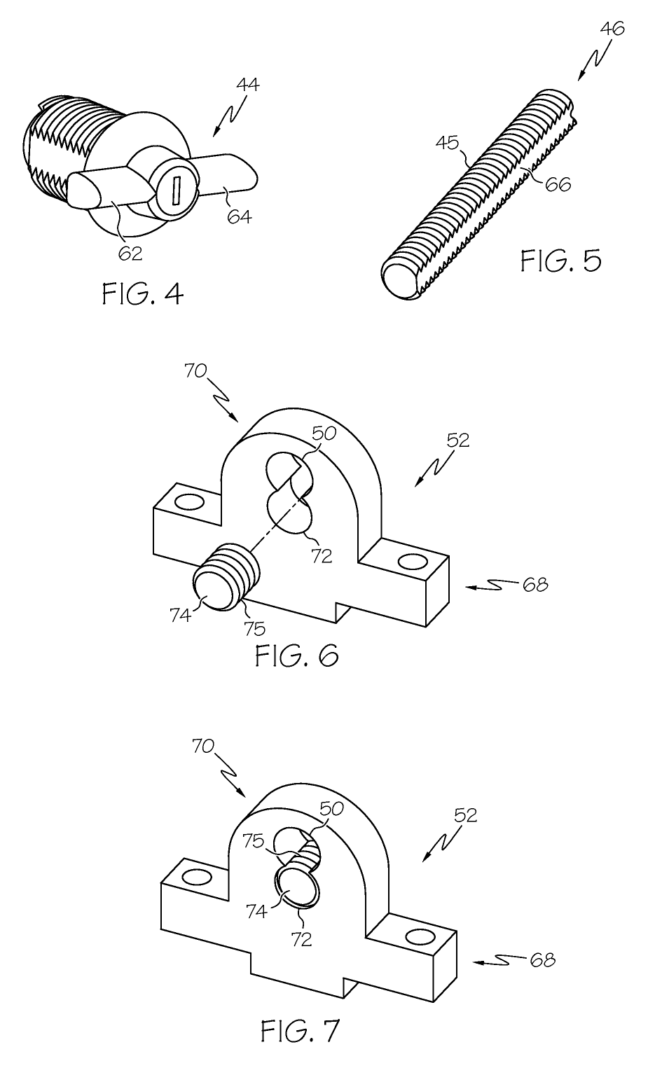

Referring to FIG. 4-7, the cam lock component 44, the lock shaft component 46 and the lock plate 52, respectively, are shown in isolation. Referring to FIG. 4, the cam lock component 44 may be a bulkhead style nut that attaches the cam lock to the sliding component 18. Wings 62 and 64 may be provided for providing leverage for an operator's thumb and forefinger in operating the locking system 40. In some embodiments, the cam lock component 44 may include a security feature such as a lock and key that prevents rotation of the cam lock component 44 and placement of the locking system 10 in the unlocked configuration. Referring to FIG. 5, the lock shaft component 46 may be a threaded shaft with a milled flat, non-threaded surface 66 on one or more sides. Once milled, the remaining threads 45 may be deburred and cleaned. In some embodiments, the milled flat surface 66 may extend over all or some of the length of the lock shaft component 46. The milled flat surface 66 may be further from the major diameter of the threads 45 than the depth of the threads so that a smooth flat surface is created. In other words, the milled flat surface 66 may be formed within the minor diameter of the lock shaft component 46.

Referring to FIGS. 6 and 7, the lock plate 52 includes a mounting portion 68 for mounting the lock plate to the sliding component 16 and a support portion 70 including the opening 50 for slidably receiving the lock shaft component 46. Opening 50 overlaps or intersects with opening 72 forming a figure eight like shape. The diameters of the openings 50 and 72 may be about the same or different sizes. The overlap of these openings 50 and 72 may be larger than the thread depth of the lock shaft component 46 or a threaded locking rod 74. The threaded locking rod 74 may have the same thread size and pitch of the lock shaft component 46. The threaded locking rod 74 may be shorter than the lock shaft component 46 and may be inserted into the opening 72 and locked in place, for example, using an adhesive or weld bead.

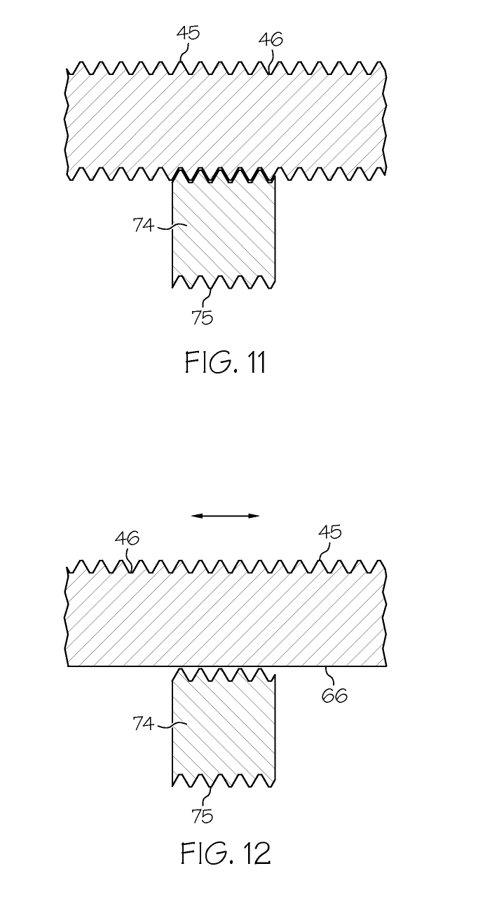

FIGS. 8-10 illustrate operation of the locking system 40. Referring to FIG. 8, the locking system 40 is illustrated in the locked configuration with the flat surface 66 rotated out of alignment (e.g., at least about 90 degrees) with the threaded locking rod 74 and with the threads 45 of the lock shaft component 46 engaged with the threads 75 of the threaded locking rod 74 (see also FIG. 11). In this locked configuration, the lock plate 52 can no longer slide along the length of the lock shaft component 46.

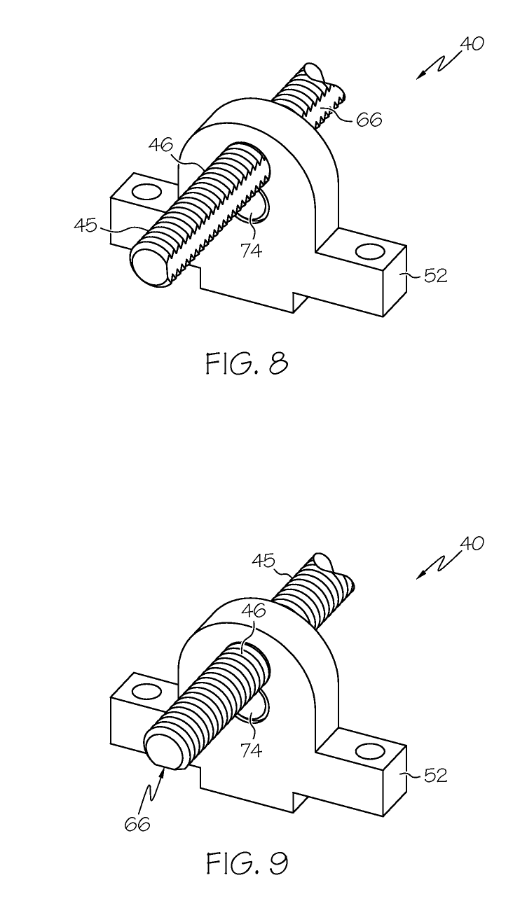

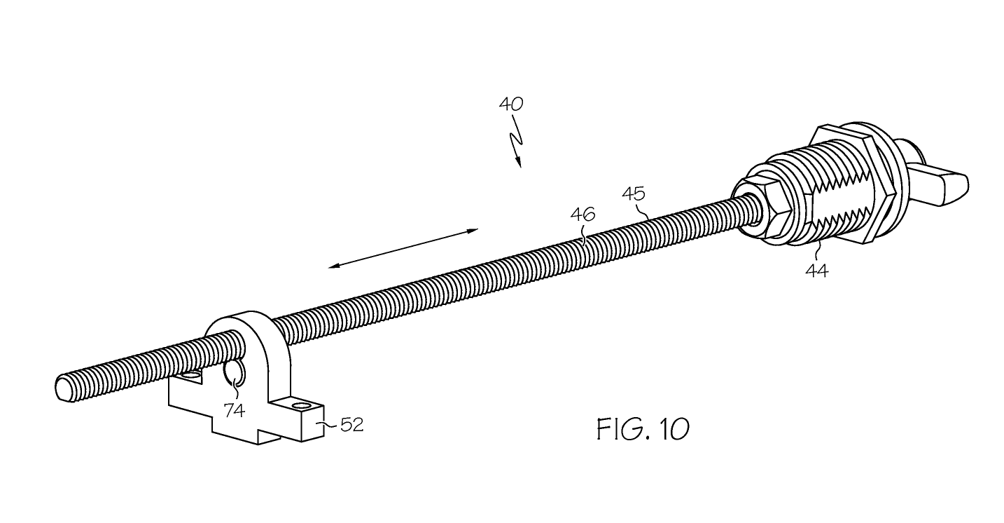

Referring to FIG. 9, the locking system 40 is illustrated in the unlocked configuration with the flat surface 66 rotated into alignment or facing the threaded locking rod 74 (see also FIG. 12). In this unlocked configuration, the threads 75 of the threaded locking rod 74 are no longer engaged with the threads 45 of the lock shaft component 46 and the lock plate 52 can freely slide along the length of the lock shaft component 46 as shown by FIG. 10.

FIG. 10 may also be used to illustrate another embodiment not including the lock shaft mount 54. In this embodiment, the lock plate 52 may be mounted to the sliding component 16 and the cam lock component 44 may be connected to the sliding component 18 in a fashion similar to that depicted by FIG. 3. The lock shaft mount 54 may instead be a stop, such as a nut that is used to limit movement of the lock plate 52 along the length of the lock shaft component 46.

The above-described mounting assembly 10 including the locking system 40 allows for an adjustable mounting system that can be used to mount a variety of devices to a support structure, such as laptops, handheld computing devices, e-readers, tablet PCs, medical equipment, etc. The support structure may be within a vehicle, such as a plane or automobile, or the support structure may be within a building or other structure, such as a house, school, hospital or other business. The mounting assembly 10 may include any suitable mounting structure for mounting to the support structure such as straps, fasteners, brackets, clips, etc. The locking system 40 allows for high strength locking of the tray components 16 and 18 of the mounting tray 14 at multiple incremental positions at any point along the length of the lock shaft component 46 as opposed to only a few set locked positions.

It is noted that terms like “preferably,” “generally,” “commonly,” and “typically” are not utilized herein to limit the scope of the claimed embodiments or to imply that certain features are critical, essential, or even important to the structures or functions. Rather, these terms are merely intended to highlight alternative or additional features that may or may not be utilized in a particular embodiment.

For the purposes of describing and defining the various embodiments it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

All documents cited in the Detailed Description are, in relevant part, incorporated herein by reference; the citation of any document is not to be construed as an admission that it is prior art. To the extent that any meaning or definition of a term in this written document conflicts with any meaning or definition of the term in a document incorporated by reference, the meaning or definition assigned to the term in this written document shall govern.

While particular embodiments have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A mounting assembly for mounting equipment thereon, the mounting assembly comprising:
an adjustable mounting tray having an upper support surface for supporting equipment thereon, the adjustable mounting tray comprising a first tray component and a second tray component where at least one of the first and second tray components is moveable relative to the other of the first and second tray components to adjust a dimension of the adjustable mounting tray; and
a locking system comprising:
a lock plate mounted to the first tray component;
a lock shaft component rotatably received within an opening of the lock plate;
wherein, with the locking system in a locked configuration, the lock shaft component engages the lock plate which locks the positions of the first and second tray component relative to each other;
wherein, with the locking system in an unlocked configuration, the lock shaft component disengages the lock plate such that the lock plate moves along a length of the lock shaft component to move at least one of the first and second tray components relative to the other of the first and second tray components.

2. The mounting assembly of claim 1 further comprising a lock shaft mount mounted to the second tray component, the lock shaft mount rotatably supporting the lock shaft component.

3. The mounting assembly of claim 1 further comprising a hook-like mounting finger extending upwardly from the mounting tray, the mounting finger including an overhanging portion that overhangs the upper support surface.

4. The mounting assembly of claim 1, wherein the lock shaft component comprises a threaded rod that includes a non-threaded surface that extends along a length of the threaded rod.

5. The mounting assembly of claim 4, wherein the lock plate includes the opening, which is a first opening that receives the lock shaft component, the lock plate further including a threaded locking rod that is received within a second opening that intersects the first opening such that threads of the threaded locking rod engage the threads of the lock shaft component with the locking system in the locked configuration.

6. The mounting assembly of claim 5, wherein the second opening intersects the first opening such that the threads of the threaded locking rod do not engage threads of the lock shaft component with the locking system in the unlocked configuration, the non-threaded surface of the lock shaft component facing the threads of the threaded locking rod.

7. The mounting assembly of claim 1 further comprising a cam lock component connected to the lock shaft component, the cam lock component including graspable structure that is accessible to an operator for rotating the lock shaft component to place the locking system in the locked and unlocked configurations.

8. The mounting assembly of claim 1 further comprising a computer mounted upon the upper support surface.

9. A locking system for use in adjusting a mounting assembly, the locking system comprising:
a lock plate;
a lock shaft mount;
a lock shaft component rotatably received within an opening of the lock plate and rotatably supported by the lock shaft mount;
wherein, with the locking system in a locked configuration, the lock shaft component engages the lock plate which locks the positions of the of the lock plate relative to the position of the lock shaft mount;
wherein, with the locking system in an unlocked configuration, the lock shaft component disengages the lock plate such that the lock plate moves along a length of the lock shaft component toward and away from the lock shaft mount.

10. The locking system of claim 9, wherein the lock shaft component comprises a threaded rod that includes a non-threaded surface that extends along a length of the threaded rod.

11. The locking system of claim 10, wherein the lock plate includes the opening, which is a first opening that receives the lock shaft component, the lock plate further including a threaded locking rod that is received within a second opening that intersects the first opening such that threads of the threaded locking rod engage the threads of the lock shaft component with the locking system in the locked configuration.

12. The locking system of claim 11, wherein the second opening intersects the first opening such that the threads of the threaded locking rod do not engage threads of the lock shaft component with the locking system in the unlocked configuration.

13. The locking system of claim 9 further comprising a cam lock component connected to the lock shaft component, the cam lock component including graspable structure that is accessible to an operator for rotating the lock shaft component to place the locking system in the locked and unlocked configurations.

14. A method of mounting equipment to a support structure, the method comprising:
adjusting a dimension of an adjustable mounting tray having an upper support surface for supporting equipment thereon, the adjustable mounting tray comprising a first tray component and a second tray component where at least one of the first and second tray components is moveable relative to the other of the first and second tray components to adjust the dimension of the adjustable mounting tray;
locking the positions of the first and second tray components relative to each other at any one of a plurality of incremental positions using a locking system that comprises:
a lock plate mounted to the first tray component;
a lock shaft component rotatably received within an opening of the lock plate;
wherein, with the locking system in a locked configuration, the lock shaft component engaging the lock plate which locks the positions of the first and second tray component relative to each other;
wherein, with the locking system in an unlocked configuration, the lock shaft component disengaging the lock plate such that the lock plate moves along a length of the lock shaft component to move at least one of the first and second tray components relative to the other of the first and second tray components.

15. The method of claim 14 further comprising engaging the equipment with a hook-like mounting finger extending upwardly from the mounting tray, the mounting finger including an overhanging portion that overhangs the upper support surface.

16. The method of claim 14, wherein the lock shaft component comprises a threaded rod that includes a non-threaded surface that extends along a length of the threaded rod.

17. The method of claim 16, wherein the lock plate includes the opening, which is a first opening that receives the lock shaft component, the lock plate further including a threaded locking rod that is received within a second opening that intersects the first opening such that threads of the threaded locking rod engage the threads of the lock shaft component with the locking system in the locked configuration.

18. The method of claim 17, wherein the second opening intersects the first opening such that the threads of the threaded locking rod do not engage threads of the lock shaft component with the locking system in the unlocked configuration.

19. The method of claim 18 further comprising rotating the lock shaft component such that the non-threaded surface faces the threads of the threaded locking rod.

20. The method of claim 13 further comprising a cam lock component connected to the lock shaft component, the cam lock component including graspable structure that is accessible to an operator for rotating the lock shaft component to place the locking system in the locked and unlocked configurations.
